(19) United States
(12) Patent Application Publication
(10) Pub. No.: US 2020/0081628 A1
(43) Pub. Date: Mar. 12, 2020

(54) Apparatus and Method for Monitoring Insertion and Removal of Devices

(71) Applicant: DELL PRODUCTS, LP, Round Rock, TX (US)

(72) Inventors: Hahn Norden, Austin, TX (US); Christopher D. Arzola, Round Rock, TX (US)

(21) Appl. No.: 16/129,714

(22) Filed: Sep. 12, 2018

(51) Int. Cl. G06F 3/06; G06F 9/30; G06N 5/04

(52) U.S. Cl. CPC G06F 3/0616; G06F 3/0653; G06N 5/04; G06F 3/0673; G06F 9/30098; G06F 3/0659

(57) ABSTRACT

A method includes establishing a register, and receiving a write command sent via a bus. A value of the register may be incremented in response to the write command, and a count of insertions of a device inferred based on the value of the register.

### FIELD OF THE DISCLOSURE

The present disclosure generally relates to information handling systems, and more particularly relates to counting insertion and removal events of any hardware device.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

Physical wear of electrical contacts is inferred based on a value of a counter. The counter increments with each insertion and/or removal of a memory drive or other device. As the counter increments, the electrical contacts are assumed to degrade in signal/data performance. A user may thus be notified of the physical wear, and the user may be cautioned to replace or backup the memory drive or other device to prevent data/signal loss. Moreover, when the value of the counter equals a preconfigured threshold value, a life of the memory drive or other device may expire due to maximum wear.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according to an embodiment of the present disclosure;

FIG. 2 further illustrates the information handling system, according to exemplary embodiments;

FIGS. 3-5 illustrate protection mechanisms, according to exemplary embodiments;

FIGS. 6-7 illustrate solid-state memory devices, according to exemplary embodiments;

FIGS. 8-12 illustrate more details of the solid-state memory devices, according to exemplary embodiments;

FIGS. 13-14 illustrate additional configuration details, according to exemplary embodiments; and

FIGS. 15-16 illustrate general configuration details, according to exemplary embodiments.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

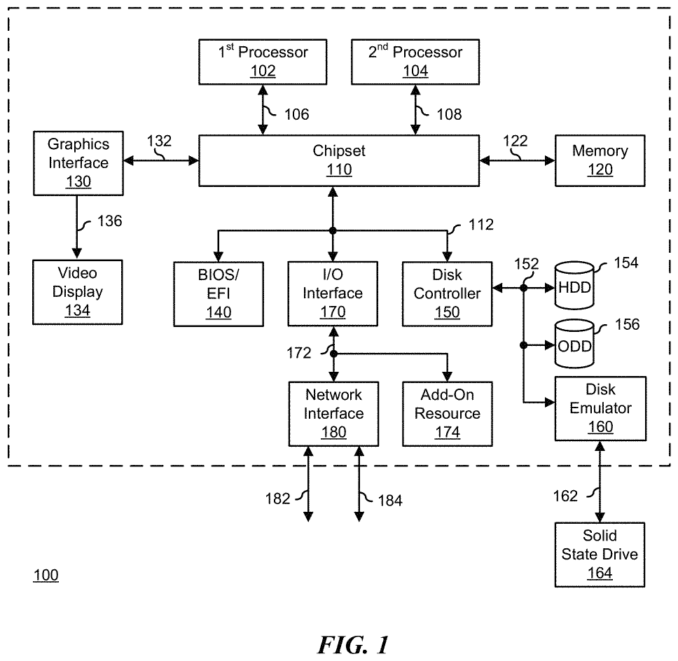

FIG. 1 illustrates a generalized embodiment of an information handling system 100. Information handling system 100 has processors 102 and 104, a chipset 110, a memory 120, a graphics interface 130, a basic input and output system/extensible firmware interface (BIOS/EFI) module 140, a disk controller 150, a disk emulator 160, an input/output (I/O) interface 170, and a network interface 180. Processor 102 is connected to chipset 110 via processor interface 106, and processor 104 is connected to chipset 110 via processor interface 108. Memory 120 is connected to chipset 110 via a memory bus 122. Graphics interface 130 is connected to chipset 110 via a graphics interface 132, and provides a video display output 136 to a video display 134. In a particular embodiment, information handling system 100 includes separate memories that are dedicated to each of processors 102 and 104 via separate memory interfaces. An example of memory 120 includes random access memory (RAM) such as static RAM (SRAM), dynamic RAM (DRAM), non-volatile RAM (NV-RAM), or the like, read only memory (ROM), another type of memory, or a combination thereof.

BIOS/EFI module 140, disk controller 150, and I/O interface 170 are connected to chipset 110 via an I/O channel 112. An example of I/O channel 112 includes a Peripheral Component Interconnect (PCI) interface, a PCI-Extended (PCI-X) interface, a high-speed PCI-Express (PCIe) interface, another industry standard or proprietary communication interface, or a combination thereof. Chipset 110 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/EFI module 140 includes BIOS/EFI code operable to detect resources within information handling system 100, to provide drivers for the resources, initialize the resources, and access the resources. BIOS/EFI module 140 includes code that operates to detect resources within information handling system 100, to provide drivers for the resources, to initialize the resources, and to access the resources.

Disk controller 150 includes a disk interface 152 that connects the disk controller 150 to a hard disk drive (HDD) 154, to an optical disk drive (ODD) 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 160 permits a solid-state drive 164 to be connected to information handling system 100 via an external interface 162. An example of external interface 162 includes a USB interface, an IEEE 1194 (Firewire) interface, a proprietary interface, or a combination thereof. Alternatively, the solid-state drive 164 (such as a non-volatile memory device) may directly connect to, or interface with, the processors 102 and/or 104.

I/O interface 170 includes a peripheral interface 172 that connects the I/O interface to an add-on resource 174 and to network interface 180. Peripheral interface 172 can be the same type of interface as I/O channel 112, or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral channel 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on separate circuit board or add-in card disposed within information handling system 100, a device that is external to the information handling system, or a combination thereof.

Network interface 180 represents a NIC disposed within information handling system 100, on a main circuit board of the information handling system, integrated onto another component such as chipset 110, in another suitable location, or a combination thereof. Network interface device 180 includes network channels 182 and 184 that provide interfaces to devices that are external to information handling system 100. In a particular embodiment, network channels 182 and 184 are of a different type than peripheral channel 172 and network interface 180 translates information from a format suitable to the peripheral channel to a format suitable to external devices. An example of network channels 182 and 184 includes InfiniBand channels, Fibre Channel channels, Gigabit Ethernet channels, proprietary channel architectures, or a combination thereof. Network channels 182 and 184 can be connected to external network resources (not illustrated). The network resource can include another information handling system, a data storage system, another network, a grid management system, another suitable resource, or a combination thereof.

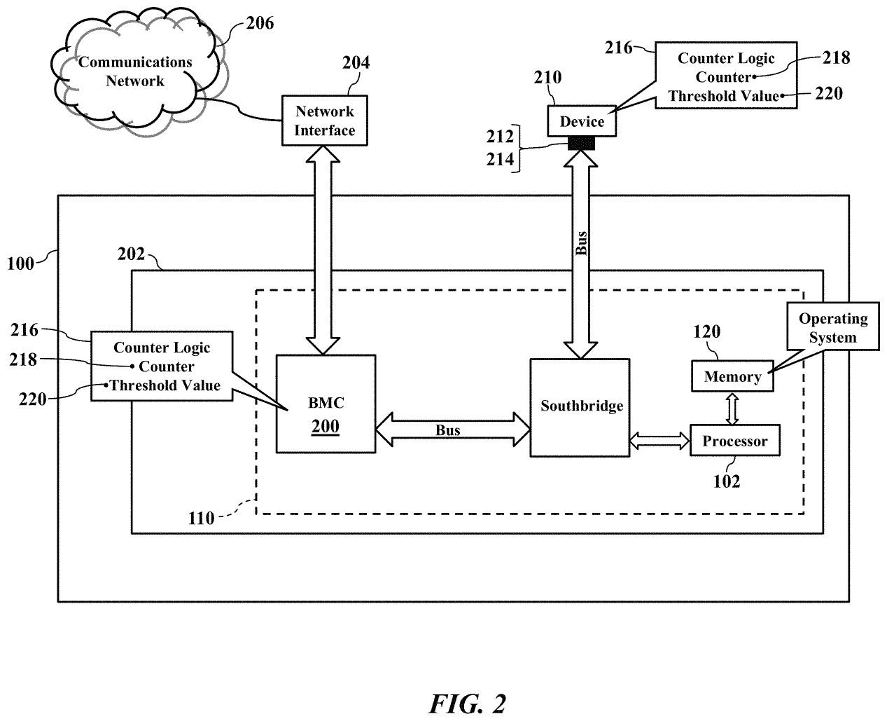

FIG. 2 further illustrates the information handling system 100, according to exemplary embodiments. Here the information handling system 100 may also include a baseboard management controller 200. As those of ordinary skill in the art understand, the baseboard management controller 200 has its own management processor and memory device (not shown for simplicity) that interfaces with a motherboard 202 to provide side-band and out-of-band remote management (perhaps according to the Intelligent Platform Management Interface specification). The baseboard management controller 200 has one or more physical communications links and interfaces to the motherboard 202, thus allowing the baseboard management controller 200 to communicate via multiple paths with the motherboard 202. The baseboard management controller 200 may thus monitor and remotely report the functions and performance of the information handling system 100 via a separate network interface 204 to a communications network 206. The baseboard management controller 200 and the IPMI specification are generally well known and thus need not be explained in detail.

Exemplary embodiments may track insertions and removals of any device 210. As the reader may understand, solid-state memory drives, peripheral drives, printers, mice, displays/monitors, and any other device 210 may be plugged into, and then removed from, the information handling system 100. The device 210, in other words, may be hot-swapped or hot-plugged many times, and each insertion/removal wears the physical, electrical contacts 212. Eventually a physical wear 214 is great enough to degrade electrical connection, thus compromising data transfer and error/failure results.

FIG. 2, though, illustrates counter logic 216. The counter logic 216 counts, or estimates, the number of times that the device 210 has been inserted and/or removed from the information handling system 100. The counter logic 216 may be implemented in the information handling system 100 (such as stored and/or executed by the baseboard management controller 200), and/or the counter logic 216 may be implemented in the device 210. Indeed, the baseboard management controller 200 and the device 210 may cooperate to store and/or to execute the counter logic 216. Regardless, the counter logic 216 maintains a counter 218 that tracks cycles of insertions and removals. When the counter 218 reaches or equals predefined values, exemplary embodiments may then notify a user of degraded electrical performance. Indeed, when the counter 218 satisfies a final value, exemplary embodiments may infer that the chance of data loss is too great to continue. Exemplary embodiments may thus track and enforce the counter's final value, perhaps even locking out the device 210 from further use. Exemplary embodiments protect the device 210 from electrical degradation and data loss.

Exemplary embodiments thus present an elegant solution. As the device 210 is inserted and removed, over time its electrical contacts experience the wear 214 and degrade, thus compromising signal/data transmission. Exemplary embodiments implement the counter logic 216 that counts, or estimates, the number of times that the device 210 has been inserted and/or removed. The current value of the counter 218 may then be monitored and compared to the various threshold values 220. The current value of the counter 218 may thus represent an estimate of the wear 214 on the electrical contacts. As the current value of the counter 218 grows or increases, exemplary embodiments may assume or infer that physical wear 214 is concomitantly increasing and electrical performance is degrading. A user of the information handling system 100 and/or device 210 may thus be notified or warned of the count. Simply put, exemplary embodiments protect the user's data and the device 210 from excessive wear 214 and data loss.

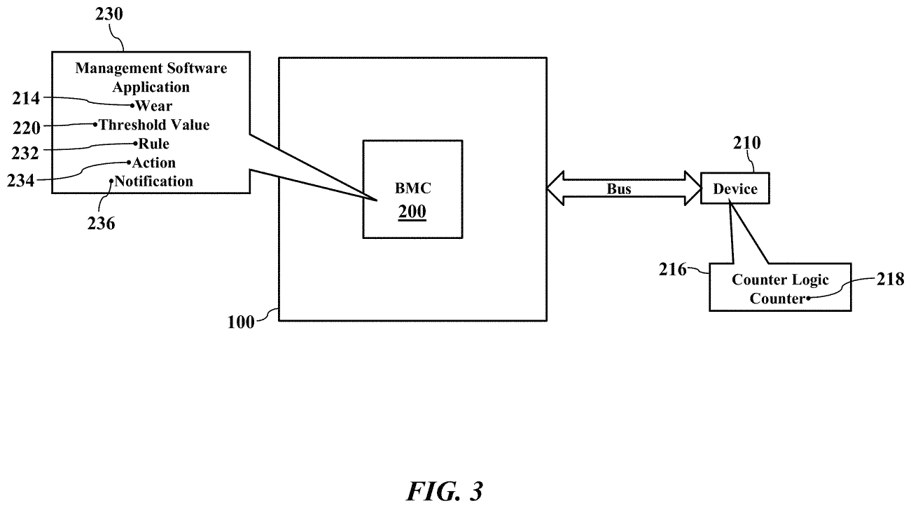

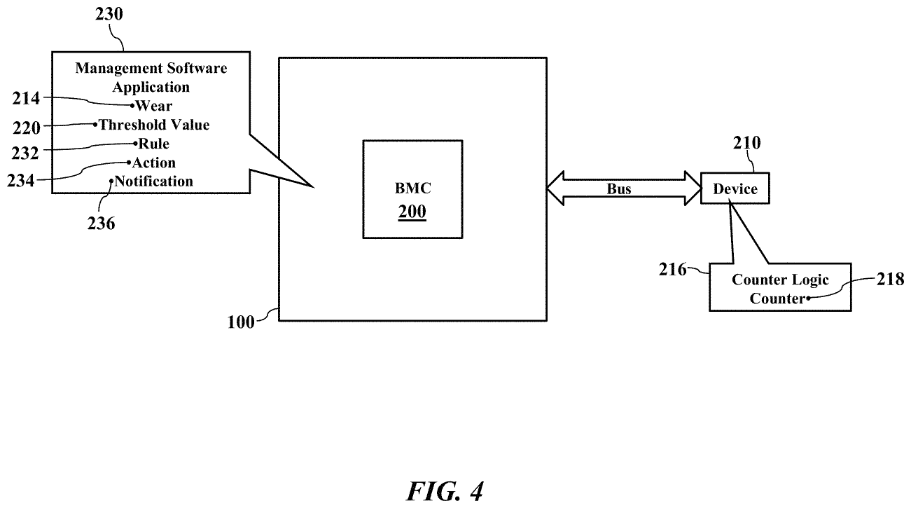

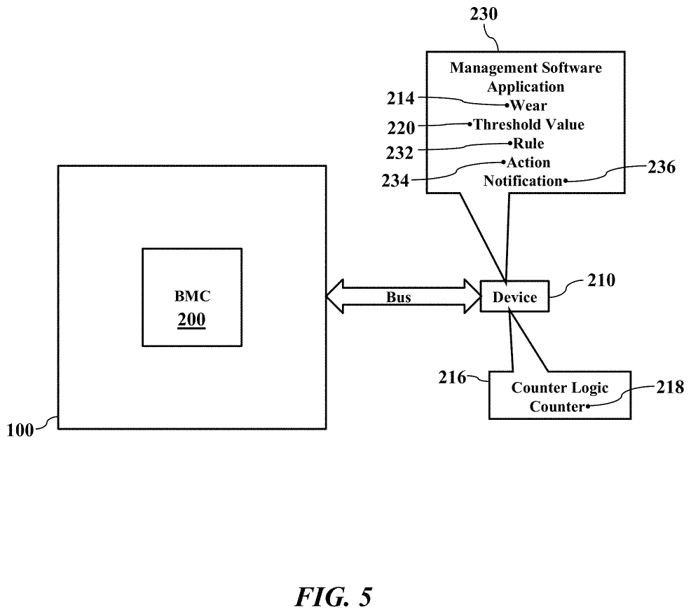

FIGS. 3-5 illustrate protection mechanisms, according to exemplary embodiments. The counter logic 216 cooperates with a management software application 230. FIG. 3 illustrates the counter logic 216 implemented in the device 210 and the management software application 230 stored in and executed by the baseboard management controller 200. The device 210 may thus track its insertions and removals (via the counter 218) and the baseboard management controller 200 manages usage and the wear 214 estimates of the device 210 based on the value of the counter 218. FIG. 4 illustrates the management software application 230 locally stored and executed by the host information handling system 100. Again, the device 210 may track its insertions and removals (via the counter 218) and the host information handling system 100 manages usage and wear 214 estimates of the device 210 (based on the value of the counter 218). FIG. 5 illustrates a local scheme in which the device 210 autonomously counts its insertions and removals (via the counter 218) and also manages its usage and wear 214. Regardless of the protection mechanism, exemplary embodiments may count, or estimate, the insertion number of times that the device 210 is inserted into a physical slot, port, or connector. The counter logic 216 may also count, or estimate, a withdrawal number of times that the device 210 is withdrawn from the physical slot, port, or connector. The counter logic 216 may additionally or alternatively count, or estimate, a number of cycles that the device 210 has endured (e.g., insertion and withdrawal). Regardless, the counter 218 increments from an initial value to a current value. The counter logic 216 may then send or communicate the current value of the counter 218 to the management software application 230.

Monitoring and notification may occur. When the management software application 230 receives and/or reads the current value of the counter 218, the management software application 230 may compare the current value of the counter 218 to the one or more threshold values 220. Each threshold value 220 may be associated with a corresponding logical rule 232 defining or specifying an action 234. For example, a low threshold value 220 may cause the management software application 230 to execute the action 234 as generating an audible or visual notification 236 that merely prompts a user to acknowledge an awareness of wear 214 (such as “the device has been inserted 58 times”). A middle or intermediate threshold value 220 may cause the management software application 230 to escalate the notification 236 to warn that further usage is limited (such as “the device may only be inserted 10 more times”). However, if the current value of the counter 218 equals or exceeds a high threshold value 220 (such as the final value), then the management software application 230 may infer that contact failure is imminent and further usage is blocked or prohibited (such as “the maximum usage of the device has been attained and no further insertions are permitted”). Each threshold value 220 and its corresponding logical rule 232 and action 234 may be defined or chosen to implement any performance, reliability/durability, and cost objective.

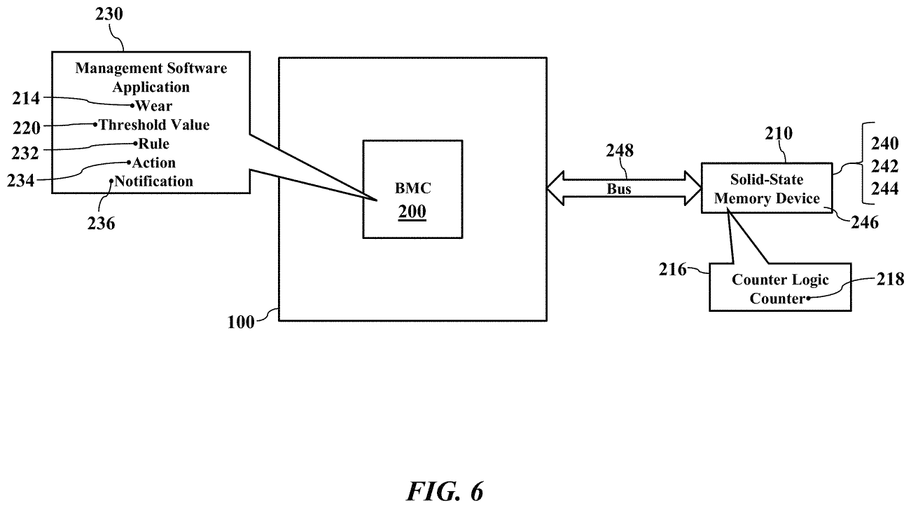

FIG. 6 illustrates a solid-state memory device (SSD) 240, according to exemplary embodiments. Here the solid-state memory device 240 is an example of the device 210 that may be removed and/or hot-swapped. Solid-state memory devices are commonly used for storing electronic documents/files, images, and other content. The solid-state memory device 240 may thus communicate with the baseboard management controller 200 and/or the host information handling system 100 via any bus or network technology (such as the I/O channel 112, the I/O interface 170, and/or the peripheral interface 172 explained with reference to FIG. 1). The solid-state device 210 has a hardware processor 242 and a solid-state non-volatile memory device 244. The hardware processor 242 and the solid-state non-volatile memory device 244 thus act or function as a drive controller 246 that implements and/or executes the counter logic 216 and increments the counter 218. When the solid-state memory device 240 is inserted (such as into a port or a backplane of the information handling system 100), or otherwise connected to and communicating with the bus 248, the management software application 230 detects the solid-state memory device 240 via bus messaging. The management software application 230 may then command the counter logic 216 to increment the counter 218.

Insertions and removals may be counted. The counter logic 216 counts, or infers, the insertion number of times that the solid-state memory device 240 is inserted, the withdrawal number of times that the solid-state memory device 240 is withdrawn, and/or the number of cycles (such as insertion and withdrawal). The current value of the counter 218 and the threshold value(s) 220 are sent via the bus 248 and read by the management software application 230 and compared to the threshold value(s) 220. When any threshold value 220 is satisfied, the management software application 230 executes the corresponding rule 232 and action 234.

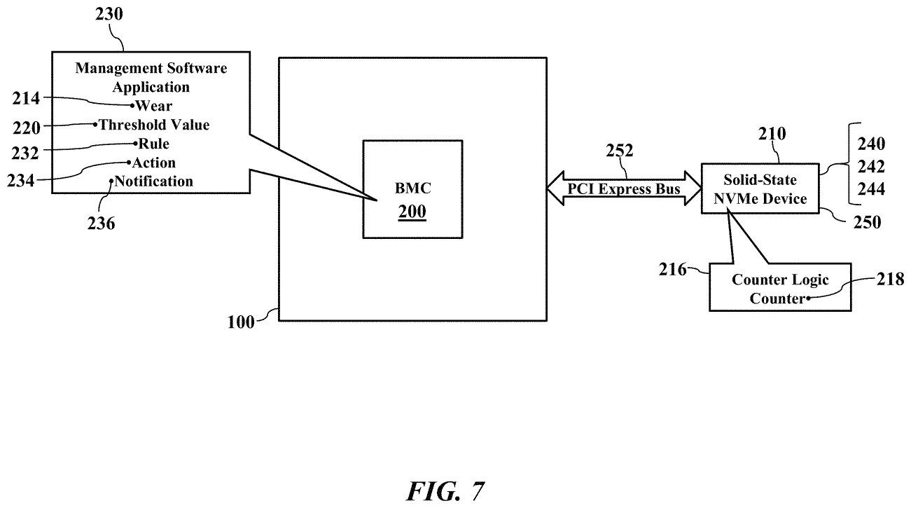

FIG. 7 also illustrates the device 210, according to exemplary embodiments. While exemplary embodiments may utilize any bus interface technology and specification, the reader may be familiar with the high-speed PCI-Express (PCIe) interface. The device 210 may thus be a solid-state NVMe drive 250 that operates according to the NVM Express (NVMe) or Non-Volatile Memory Host Controller Interface Specification (NVMHCIS) attached via a PCI Express (PCIe) bus 252. The solid-state NVMe drive 250 may implement the counter logic 216 that counts or infers the number of insertion or withdrawal events, based on the counter 218. The current value of the counter 218 is read by the management software application 230 and compared to the threshold value(s) 220. When any threshold value 220 is satisfied, the management software application 230 executes the corresponding rule 232 and action 234.

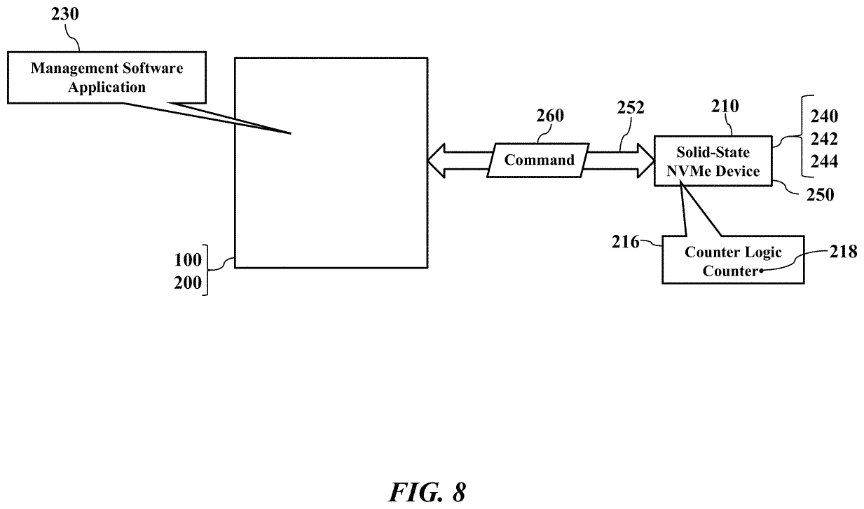

FIGS. 8-12 illustrate more details of the solid-state NVMe drive 250, according to exemplary embodiments. The solid-state NVMe drive 250 has the hardware processor 242 and the solid-state non-volatile memory device 244 that cooperate as the drive controller 246. When the solid-state NVMe drive 250 is inserted (such as into a backplane of the information handling system 100), or otherwise connected to and communicating with the PCI Express bus 252, the management software application 230 detects its presence and issues a read/write command 260 to the solid-state NVMe drive 250. When the solid-state NVMe drive 250 receives the read/write command 260, the read/write command 260 causes the counter logic 216 to increment the counter 218.

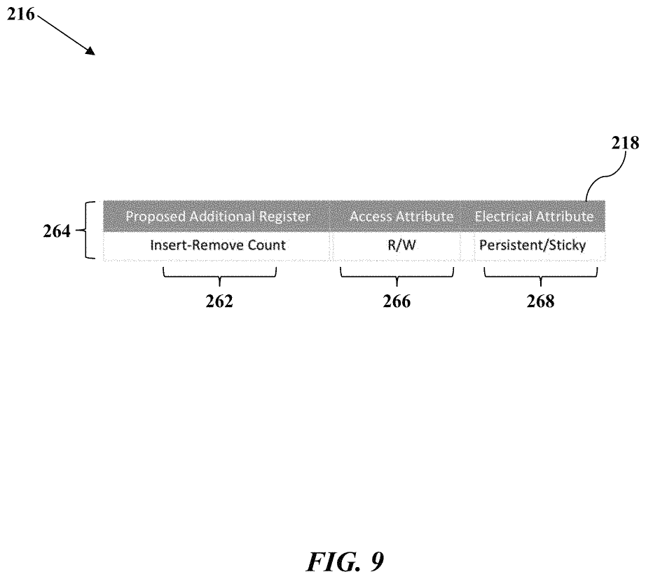

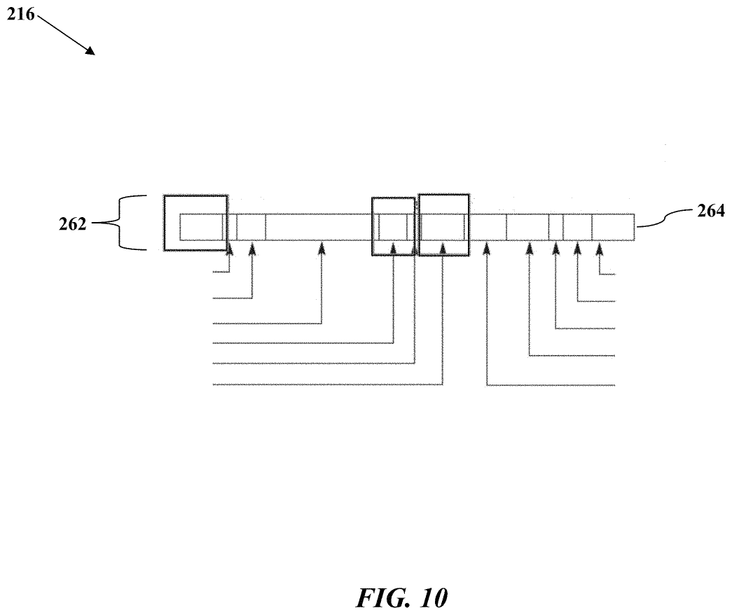

FIGS. 9-10 illustrate a configuration of the counter 218. While the counter logic 216 and the counter 218 may be implemented using custom programming, a slight modification based on the existing PCI Express Base Specification is thought easiest and cheapest to implement. Exemplary embodiments may add the counter 218 as an additional register field 262 in the device status register 264 of the PCI Express Base Specification (see § 7.8.5 of the PCI Express Base Specification, revision 3.1a, dated Dec. 7, 2015). For example, the counter 218 may be added as one of the reserved fields represented by bits 12-14, 16-17, and/or 29-31. The device status register 264 provides information about specific parameters for any PCI Express capable device (such as the solid-state device 210). The counter 218 may have a read/write access attribute 266 and a persistent/sticky electrical attribute 268. The counter 218 may thus be implemented within the baseboard management controller 200 and/or the device 210 (as illustrated by FIG. 2). The threshold value 220, for example, when stored in a register on the device 210, may accommodate cases of cost trade off where less expensive devices are capable of a lesser number of insert/remove because there is less plating on the electrical contacts 212 (again as illustrated by FIG. 2).

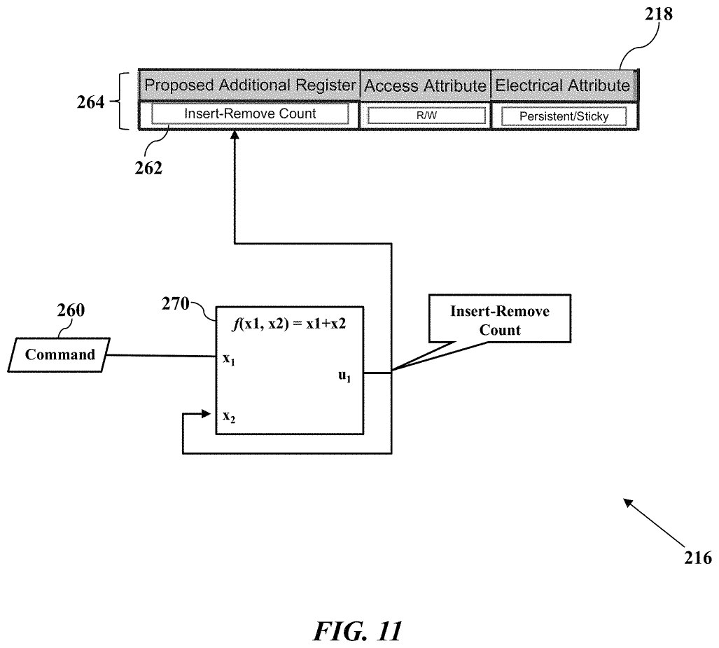

FIG. 11 illustrates the counter logic 216. When the solid-state NVMe drive 250 receives the read/write command 260 (as FIG. 9 illustrated), the read/write command 260 causes the solid-state NVMe drive 250 to conduct a read/write operation of the counter 218 in the additional register field 262 in the device status register 264. FIG. 11 illustrates the counter logic 216 as a logical adder or summer 270 having two (2) inputs and an output. The logical adder or summer 270 receives the read/write command 260 (perhaps as a high bit write payload operation) and performs a logical summation operation. For example, the added logic in a register-transfer level (RTL) silicon design may be abstracted as:

Insert-Remove Counter=Insert-Remove Count+Write Payload;

whereas the added logic for a micro-controller in the C programming language may be abstracted as

Insert-Remove Counter=+Write Payload.

The current value of the counter 218 may increment by one (1) (or by the value in the write payload). The management software application 230 may generate and issue the read/write command 260 to the solid-state NVMe drive 250 at any frequency is desired, as long as the payload captures the number of insert/remove cycles having occurred since the last read/write issued. Exemplary embodiments may prefer that the counter 218 is updated/written to upon a single insert to minimize inaccuracy, such as in cases where the solid-state NVMe drive 250 is removed prior to the management software application 230 writing out the value of the counter 218 at hand.

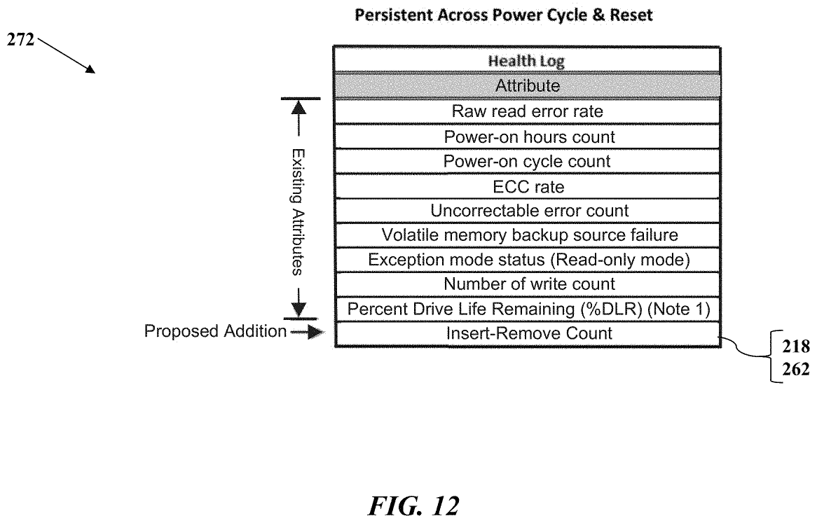

FIG. 12 illustrates count reporting. Because the counter 218 may be implemented as the additional register field 262 in the device status register 264 (as explained with reference to FIG. 9), exemplary embodiments may map or log the register field 262 and/or the device status register 264 in any memory device (such as the solid-state non-volatile memory device 244, as explained with reference to FIGS. 7-8). The current value of the counter 218 may be thus be stored, identified, read, retrieved, and/or sent to the management software application 230 (such as via the in-band PCI Express bus 252 and/or any side-band bus, such as I²C, as above explained and illustrated). The content in the additional register field 262 may thus be read and included to the list of registers such that the current value is returned as a part of a health query 272.

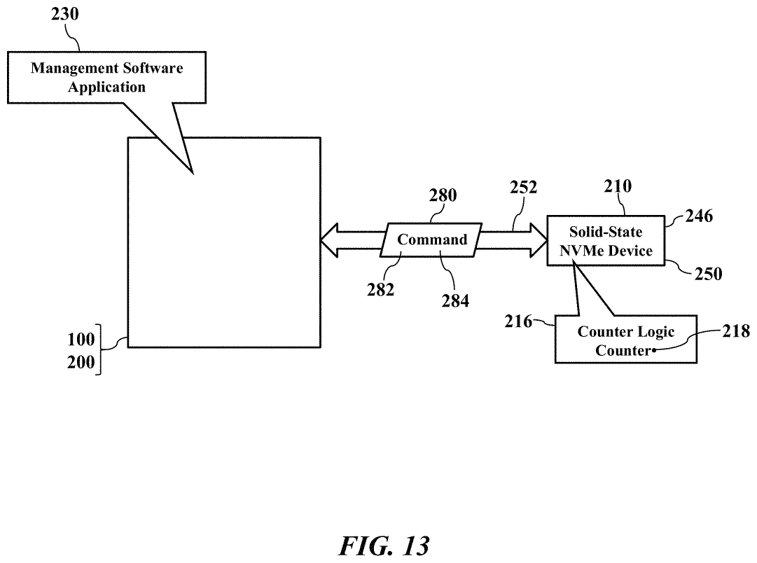

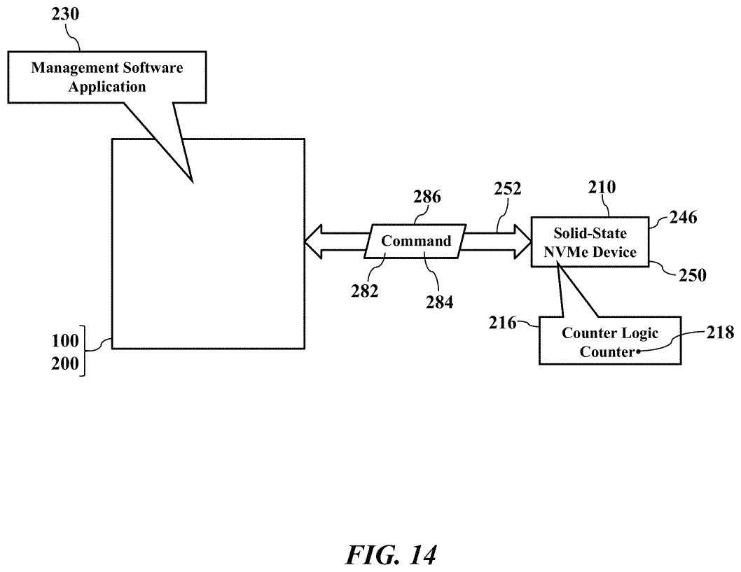

FIGS. 13-14 illustrate additional configuration details, according to exemplary embodiments. Upon an insertion of the solid-state NVMe drive 250, the management software application 230 is informed of its presence (perhaps via a message conveyed along the PCI Express bus 252) and generates/sends a set features command 280 to the solid-state NVMe drive 250. The set features command 280 may use a new feature identification 282 (or feature ID) that identifies, or is associated with, the counter 218. The set features command 280 may additionally or alternatively use a new sub-identifier 284 (or sub-feature ID) if leveraging an existing feature ID. Regardless, the drive controller 246 utilizes the counter logic 216 to process and increment the counter 218. As FIG. 14 illustrates, the management software application 230 may additionally or alternatively send a get features command 286 to the solid-state NVMe drive 250, and the get features command 286 may specify the feature identification 282 and/or the sub-identifier 284. When the solid-state NVMe drive 250 receives the get features command 286, the counter logic 216 reads or retrieves the current value of the counter 218 and sends a response back to the management software application 230.

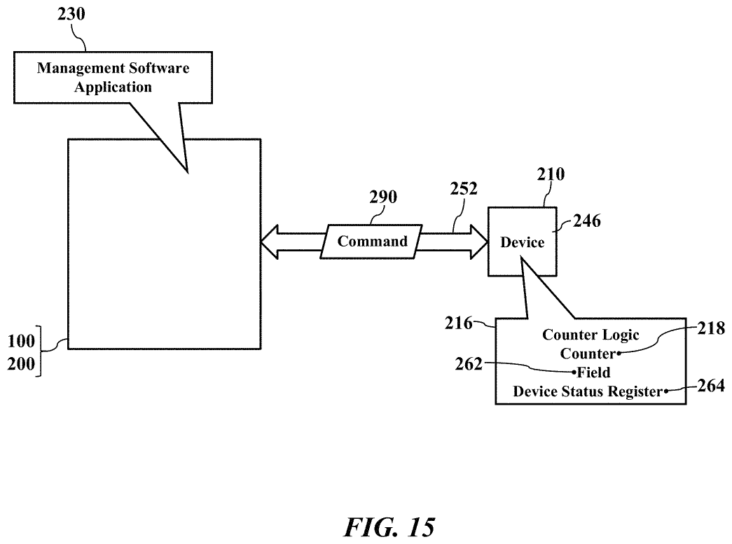

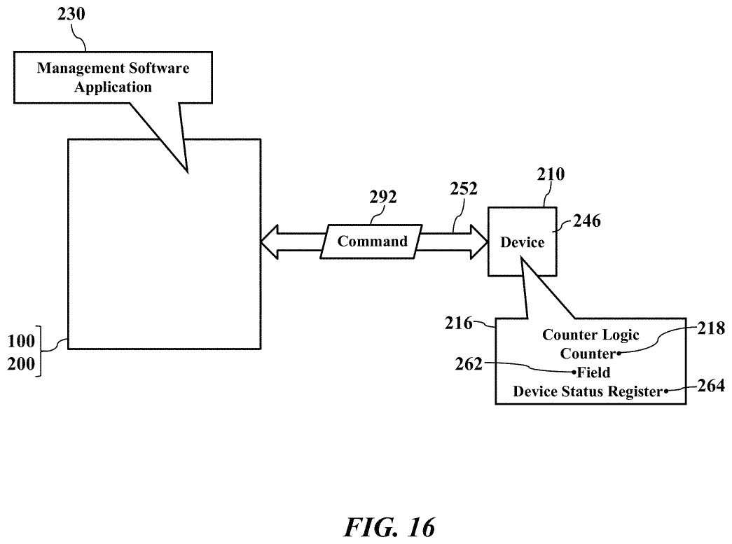

FIGS. 15-16 illustrate general configuration details, according to exemplary embodiments. Here the device 210 may be any endpoint that operates or uses the PCI Express Base Specification. The device 210, in other words, may be any peripheral memory drive, external/internal drive, printer, mouse or track pad, display or monitor, smartphone, mobile device, or any other processor-controlled device 210 that may be plugged into, and then removed from, the information handling system 100. Here again the counter 218 may be implemented as the field 262 in the device status register 264, as defined by the PCI Express Base Specification. The counter 218 may utilize currently reserved bits (such as bits #6-15). Upon insertion of the device 210, a configuration write command 290 is sent via the PCI Express bus 252 to the drive controller 246. The configuration write command 290 causes the drive controller 246 to utilize the counter logic 216 to increment the device status register 264. As FIG. 16 illustrates, the management software application 230 may additionally or alternatively send a configuration read command 292 to the drive controller 246, and the configuration read command 292 causes the drive controller 246 (executing the counter logic 216) to read the bits in the device status register 264 that represent the current value of the counter 218. The drive controller 246 sends a response back to the management software application 230, and the response represents the current value of the counter 218.

Exemplary embodiments thus present an elegant solution. As the device 210 is inserted and removed, over time its electrical contacts wear 214 and degrade, thus compromising signal/data transmission. Exemplary embodiments, implement the counter logic 216 that counts, or estimates, the number of times that the device 210 has been inserted and/or removed. The current value of the counter 218 may then be monitored and compared to the various threshold values 220. The current value of the counter 218 may thus represent an estimate of the wear 214 on the electrical contacts. As the current value of the counter 218 grows or increases, exemplary embodiments may assume or infer that the physical wear 214 is concomitantly increasing and electrical performance is degrading. A user of the device 210 may thus be notified or warned of the count. Simply out, exemplary embodiments protect the user's data and device 210 from excessive wear 214 and data loss.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In the embodiments described herein, an information handling system includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system can be a personal computer, a consumer electronic device, a network server or storage device, a switch router, wireless router, or other network communication device, a network connected device (cellular telephone, tablet device, etc.), or any other suitable device, and can vary in size, shape, performance, price, and functionality.

The information handling system can include memory (volatile (such as random-access memory, etc.), nonvolatile (read-only memory, flash memory etc.) or any combination thereof), one or more processing resources, such as a central processing unit (CPU), a graphics processing unit (GPU), hardware or software control logic, or any combination thereof. Additional components of the information handling system can include one or more storage devices, one or more communications ports for communicating with external devices, as well as, various I/O devices, such as a keyboard, a mouse, a video/graphic display, or any combination thereof. The information handling system can also include one or more buses operable to transmit communications between the various hardware components. Portions of an information handling system may themselves be considered information handling systems.

When referred to as a “device,” a “module,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

1. An apparatus comprising:
a hardware processor; and
a memory device storing instructions that when executed cause the hardware processor to perform operations, the operations including:
establishing a register in the memory device;
receiving a write command to write data to the memory device;
in response to the write command, incrementing a value of the register; and
inferring a count of insertions of the apparatus based on the value of the register.

2. The apparatus of claim 1, wherein the operations further include reading the value of the register.

3. The apparatus of claim 1, wherein the operations further include inferring a wear of an electrical contact based on the value of the register.

4. The apparatus of claim 1, wherein the operations further include comparing the value of the register to a threshold value.

5. The apparatus of claim 4, wherein the operations further include generating a wear notification in response to the value of the register equaling or exceeding the threshold value, the wear notification notifying of a wear of an electrical contact based on the value of the register.

6. The apparatus of claim 1, wherein the operations further include prompting for an acknowledgment of the count of the insertions of the device.

7. The apparatus of claim 1, wherein the operations further include persistently storing the value of the register as the count of the insertions.

8. A method of monitoring insertions of a memory device, the method comprising:
establishing, by the memory device, a register;
receiving, by the memory device, a write command sent via a bus;
in response to the receiving of the write command, incrementing, by the memory device, a value of the register; and
inferring physical wear of an electrical contact to the bus based on the value of the register.

9. The method of claim 8, further comprising inferring a count of insertions of the memory device based on the value of the register.

10. The method of claim 8, further comprising reading the value of the register.

11. The method of claim 8, further comprising comparing the value of the register to a threshold value.

12. The method of claim 11, further comprising generating a wear notification in response to the value of the register equaling or exceeding the threshold value, the wear notification notifying of the physical wear of the electrical contact.

13. The method of claim 9, further comprising prompting for an acknowledgment of the count of the insertions of the device.

14. The method of claim 8, further comprising persistently storing the value of the register.

15. A device for storing instructions that when executed cause a hardware processor to perform operations, the operations comprising:
establishing a register;
receiving a write command via an electrical connection to a bus;
in response to the receiving of the write command, incrementing a value of the register; and
inferring a physical wear of the electrical connection to the bus based on the value of the register.

16. The device of claim 15, wherein the operations further include inferring a count of insertions based on the value of the register.

17. The device of claim 15, wherein the operations further include inferring a count of removals based on the value of the register.

18. The device of claim 15, wherein the operations further include comparing the value of the register to a threshold value.

19. The device of claim 18, wherein the operations further include generating a wear notification in response to the value of the register equaling or exceeding the threshold value, the wear notification notifying of the physical wear.

20. The device of claim 18, wherein the operations further include blocking a usage based on the value of the register equaling or exceeding the threshold value.
